(19) United States
(12) Patent Application Publication
(10) Pub. No.: US 2024/0373382 A1
(43) Pub. Date: Nov. 7, 2024

(54) COMMUNICATION APPARATUS, CONTROL CIRCUIT, AND CLOCK DRIFT CALCULATION TIMING DETERMINATION METHOD

(71) Applicant: Mitsubishi Electric Corporation, Tokyo (JP)

(72) Inventors: Ryo MATSUNAGA, Tokyo (JP); Masao OGA, Tokyo (JP); Keijiro TAKE, Tokyo (JP)

(73) Assignee: Mitsubishi Electric Corporation, Tokyo (JP)

(21) Appl. No.: 18/774,550

(22) Filed: Jul. 16, 2024

Related U.S. Application Data
(63) Continuation of application No. PCT/JP2022/006449, filed on Feb. 17, 2022.

(51) Int. Cl. H04W 56/00; H04L 7/00

(52) U.S. Cl. CPC H04W 56/004; H04L 7/0033; H04W 56/0055

(57) ABSTRACT

A terminal-side communication apparatus that transfers signals between a first network and a second network includes a wireless time synchronizer capable of time-synchronizing with the first network, a wireless time real-time clock that outputs the time in the first network, a wireless interface that stamps a reception time when receiving a signal from the first network, and a propagation delay variation monitoring unit that stores a propagation delay correction command value, time information contained in a signal, and the reception time of the time information, the propagation delay correction command value and the signal being received by the wireless interface, determines the state of propagation delay in the first network, using the propagation delay correction command value, the time information, and the reception time, and determines that timing to calculate clock drift with respect to the first network is provided when the propagation delay is within an acceptable level.

### CROSS-REFERENCE TO RELATED APPLICATION

This application is a continuation application of International Application PCT/JP2022/006449, filed on Feb. 17, 2022, and designating the U.S., the entire contents of which are incorporated herein by reference.

### BACKGROUND OF THE INVENTION

### 1. Field of the Invention

The present disclosure relates to a communication apparatus, a control circuit, and a clock drift calculation timing determination method in the 5th Generation (5G) system.

### 2. Description of the Related Art

In the 3rd Generation Partnership Project (3GPP), the 5G system has a function as a virtual bridge to support Time-Sensitive Communications (TSC) between control devices disposed on Time-Sensitive Networking (TSN) outside the 5G system. In addition, the 5G system is extended and standardized in TSC operation as a non-TSN bridge, for example, as a transparent clock or a boundary clock of the Precision Time Protocol (PTP). When a Sync message, which is a time synchronization message, is input to an input port, the 5G system stores the 5G system time at the input port as a 5G system input timestamp. The 5G system records the 5G system input timestamp in an extended format area of the Sync message or a Follow_Up message, and then bridges the messages in the 5G system. The Follow_Up message, which is a message input immediately after the Sync message, has the same sequence number as the Sync message.

The 5G system calculates the 5G system time at which the Sync message of the bridged time synchronization messages is output as a 5G system output timestamp, and reflects, in the correction field value, a value that is a difference value between the 5G system input timestamp and the 5G system output timestamp in which the amount of clock drift is taken into consideration. As the above-described processing reflects a residence time in the 5G system in a time synchronization message between bridged networks, the 5G system allows time synchronization. For the technique disclosed in, for example, WO 2020/259134 A, a communication apparatus corresponding to a network apparatus calculates clock drift to update the value of Time Sensitive Communication Assistance Information (TSCAI), allowing more efficient 5G system operation. A virtual bridge via a wireless system is based on the assumption that an input port of a time synchronization message and an output port of the time synchronization message have the same wireless system clock. It is known that a time synchronization message can be bridged with higher precision by considering the clock drift of a wireless system clock also in a communication apparatus corresponding to a terminal, in addition to the calculation of the clock drift of a communication apparatus corresponding to a network apparatus.

The wireless system time is handled by a communication apparatus corresponding to a network apparatus such as a wireless base station or a core network in the 5G system, etc., in which case the communication apparatus corresponding to the network apparatus, which can be wire-connected to a 5G system time grand master clock, can achieve high-precision synchronization by using a timing synchronization technology at the physical layer such as Synchronous Ethernet (SyncE (registered trademark)) in addition to using a time synchronization protocol premised on packet switching such as PTP. In this case, the communication apparatus corresponding to the network apparatus can use the packet switching in calculating clock drift, as well as in providing the high-precision synchronization of the 5G system time. On the other hand, a communication apparatus corresponding to a terminal, which handles the 5G system time, may use a packet switching time synchronization protocol such as PTP via a radio channel using the 5G system time grand master clock and a user data plane path, time synchronization using a wireless interface, Global Navigation Satellite System (GNSS), etc. When a network is constructed for a typical control device application, however, the communication apparatus corresponding to the terminal cannot use the time synchronization by GNSS under some environment as it is expected that the communication apparatus is used indoors. For time synchronization using a wireless interface, there is known a technology of time-synchronizing with the 5G system time while compensating for propagation delay, using a System Information Block (SIB) and a Timing Advance (TA) command at the Radio Resource Control (RRC) layer.

According to the above conventional technique, a communication apparatus corresponding to a terminal performs the time synchronization through packet switching, the time synchronization through a wireless interface, etc. in which case propagation delay may vary with, for example, the movement of the communication apparatus corresponding to the terminal. Consequently, when the communication apparatus corresponding to the terminal is synchronized with a wireless system clock in a virtual bridge via a wireless system, a problem is that the variation in propagation delay may affect the calculation of clock drift.

### SUMMARY OF THE INVENTION

To solve the above problem and achieve the object, the present disclosure provides a communication apparatus to transfer signals between a first network and a second network, the communication apparatus comprising: a time synchronizer capable of time-synchronizing with the first network; a clock to output a time in the first network; an interface to stamp the time as a reception time when receiving a signal from the first network; and a propagation delay variation monitoring unit to store: a propagation delay correction command value for correcting propagation delay from the first network; time information contained in a signal; and a reception time of the time information, the propagation delay correction command value and the signal being received by the interface, determine a state of propagation delay in the first network, using the propagation delay correction command value, the time information, and the reception time, and determine that timing to calculate clock drift with respect to the first network is provided and instruct the time synchronizer to calculate the clock drift when the propagation delay is within an acceptable level.

### BRIEF DESCRIPTION OF THE DRAWINGS

FIG. 1 is a diagram illustrating an example configuration of a TSN system in which a wireless communication system including communication apparatuses according to an embodiment virtually bridges a plurality of TSNs;

FIG. 2 is a block diagram illustrating an example configuration of a terminal-side communication apparatus according to the embodiment;

FIG. 3 is a block diagram illustrating an example configuration of a wireless base station apparatus according to the embodiment;

FIGS. 4A and 4B are flowcharts illustrating an operation to determine the timing to calculate clock drift by the terminal-side communication apparatus according to the embodiment;

FIG. 5 is a sequence diagram illustrating operations of the apparatuses until the terminal-side communication apparatus calculates clock drift in the wireless communication system according to the embodiment;

FIG. 6 is a diagram illustrating an example configuration of processing circuitry when a processor and memory implement processing circuitry for implementing the terminal-side communication apparatus according to the embodiment; and

FIG. 7 is a diagram illustrating an example of processing circuitry when dedicated hardware constitutes the processing circuitry for implementing the terminal-side communication apparatus according to the embodiment.

### DETAILED DESCRIPTION OF THE PREFERRED EMBODIMENTS

A communication apparatus, a control circuit, and a clock drift calculation timing determination method according to an embodiment of the present disclosure will be hereinafter described in detail with reference to the drawings.

### Embodiment

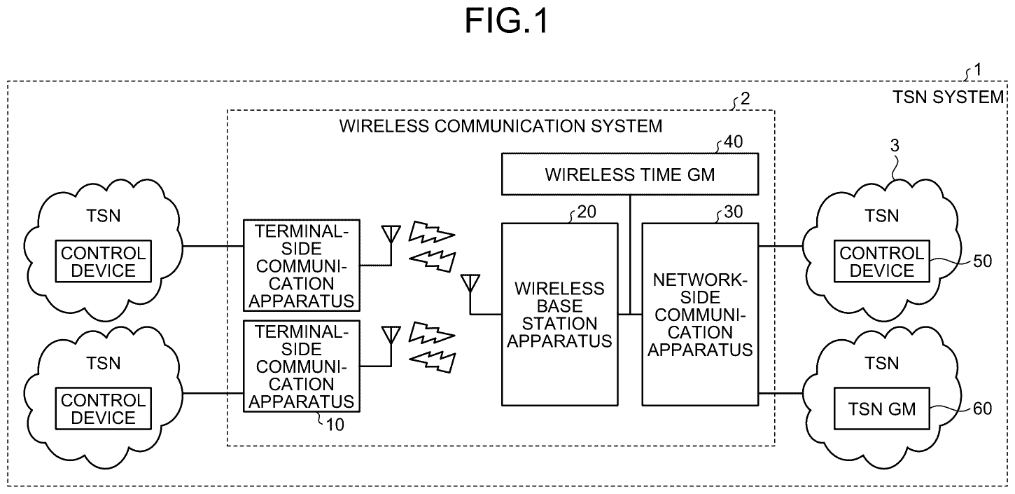

FIG. 1 is a diagram illustrating an example configuration of a TSN system 1 in which a wireless communication system 2 including communication apparatuses according to the present embodiment virtually bridges a plurality of TSNs 3. By the wireless communication system 2 virtually bridging the plurality of TSNs 3, the TSN system 1 achieves communications for applications between control devices 50 disposed on the TSNs 3 deployed at different positions without being directly physically wire-connected to one another. The TSN system 1 includes the wireless communication system 2 and the plurality of TSNs 3. The wireless communication system 2 includes terminal-side communication apparatuses 10, a wireless base station apparatus 20, a network-side communication apparatus 30, and a wireless time Grand Master (GM) 40. Each TSN 3 includes the control device 50 or a TSN GM 60. In the following description, a network in the wireless communication system 2 is sometimes referred to as a first network, and each TSN 3 as a second network.

The control devices 50, which are devices present on the TSNs 3, communicate with one another for controlling equipment in a factory, for example. All the control devices 50 highly precisely time-synchronize with the TSN GM 60 as a master clock for all the TSNs 3. The TSNs 3 use Institute of Electrical and Electronics Engineers (IEEE) 802.1AS, which is PTP in a narrow sense, or the like, so that the entire network formed by the plurality of TSNs 3 is synchronized. IEEE 802.1AS is also referred to as the generalized Precision Time Protocol (gPTP)

In a case where a time synchronization message is forwarded to all the TSNs 3, the wireless communication system 2, which is a virtual bridge, operates as a time-aware system. The wireless communication system 2 adds the wireless time at which to receive a Sync message, to an extended area of the Sync message or a Follow_Up message. The Sync message is a gPTP message input from each TSN 3 to the wireless communication system 2. Using the wireless time at which to transmit the Sync message to the TSN 3, the wireless communication system 2 then reflects, in an information element, how long the Sync message has resided in the wireless communication system 2. The Follow_Up message, which is a message immediately after the Sync message, has the same sequence number as the Sync message. The wireless communication system 2 has wired interfaces with the TSNs 3. Specifically, the terminal-side communication apparatuses 10 and the network-side communication apparatus 30 are treated as virtual TSN ports.

Each terminal-side communication apparatus 10 has a function as a mobile terminal in the wireless communication system 2. The terminal-side communication apparatus 10 includes a wireless interface with the wireless base station apparatus 20, and a wired interface as a TSN port. To establish the wireless communication system 2 as a TSN bridge, the terminal-side communication apparatus 10 simultaneously handles the time for the wireless communication system 2 and the time for the TSN 3. For this reason, the terminal-side communication apparatus 10 has a function of time-synchronizing with the wireless time GM 40 via the wireless interface. When using a typical 5G system, that is, a fifth-generation communication system, the terminal-side communication apparatus 10 performs the time synchronization under the control of the wireless base station apparatus 20 that highly precisely time-synchronizes with the wireless time GM 40. The terminal-side communication apparatus 10 has a function of transferring, to the wired interface, application traffic including a time synchronization message which the terminal-side communication apparatus 10 received from the control device 50 through the wireless interface. The terminal-side communication apparatus 10 has a function to transferring, to the wireless interface, application traffic which the terminal-side communication apparatus 10 received from the control device 50 through the wired interface. In this case, for a time synchronization message from each TSN 3, the terminal-side communication apparatus 10 adds the wireless time to an extended area at the time of receiving the time synchronization message, and reflects, in an information element, the residence time of the message in the wireless communication system 2 at the time of transmitting the time synchronization message. The terminal-side communication apparatus 10 is a communication apparatus that transfers signals such as the above-described messages between the network in the wireless communication system 2 and the TSN 3.

The network-side communication apparatus 30 has a function of controlling the wireless communication system 2. The control of the wireless communication system 2 referred to herein includes wireless access management, mobility management, subscriber information management, session management, slice management, policy and charging management, etc. between the terminal-side communication apparatuses 10 and the wireless base station apparatus 20. To establish the wireless communication system 2 as the TSN bridge, the network-side communication apparatus 30 simultaneously handles the time for the wireless communication system 2 and the time for the TSNs 3. For this reason, the network-side communication apparatus 30 has a function of time-synchronizing with the wireless time GM 40, typically performing the time synchronization through packet switching using the PTP. The network-side communication apparatus 30 has a function of transferring application traffic, which the wireless base station apparatus 20 received wirelessly and transferred thereto, to the wireless base station apparatus 20 that establishes a wireless link with the terminal-side communication apparatus 10 serving as the port for the TSN having the control device 50, i.e., the proper destination present therein, or to a wired interface of the network-side communication apparatus 30. The network-side communication apparatus 30 has a function of transferring application traffic, which the network-side communication apparatus 30 received from the control device 50 through the wired interface, to the wireless base station apparatus 20 that establishes a wireless link with the terminal-side communication apparatus 10 serving as the port for the TSN having the control device 50, i.e., the proper destination present therein, or to the TSN 3. In this case, for a time synchronization message from each TSN 3, the network-side communication apparatus 30 adds the wireless time to an extended area at the time of receiving the time synchronization message, and reflects, in an information element, the residence time of the message in the wireless communication system 2 at the time of transmitting the time synchronization message.

The wireless base station apparatus 20, which has a function as a wireless base station in the wireless communication system 2, includes a wireless interface with the terminal-side communication apparatuses 10, and a wired interface with the network-side communication apparatus 30. The wireless base station apparatus 20, which has a function of managing the establishment of wireless link with the terminal-side communication apparatuses 10, has a function of calculating the amount of wireless propagation delay between the wireless base station apparatus 20 and each terminal-side communication apparatus 10, and providing the terminal-side communication apparatus 10 with a propagation delay correction command value that is a command value for correcting the amount of the wireless propagation delay. The wireless base station apparatus 20 has a function of time-synchronization with the wireless time GM 40 in order to cause the terminal-side communication apparatuses 10 to time-synchronize with the wireless time of the wireless communication system 2 via the wireless interface. In this case, when using a typical fifth-generation communication system, the wireless base station apparatus 20 time-synchronizes with the wireless time GM 40 through packet switching using the PTP. The wireless base station apparatus 20 has a function of transferring, to the wired interface, application traffic including a time synchronization message which the wireless base station apparatus 20 received from each control device 50 through the wireless interface. The wireless base station apparatus 20 has a function of transferring, to the wireless interface, application traffic which the network-side communication apparatus 30 transferred to the wireless base station apparatus 20 after receiving the application traffic from the control device 50 through the wired interface.

Note that in FIG. 1, the wireless communication system 2 includes two terminal-side communication apparatuses 10, but may include three or more terminal-side communication apparatuses 10. The number of terminal-side communication apparatuses 10 of the wireless communication system 2 is not limited to the example of FIG. 1. In FIG. 1, the wireless communication system 2 includes one wireless base station apparatus 20, but may include two or more wireless base station apparatuses 20. The number of wireless base station apparatuses 20 of the wireless communication system 2 is not limited to the example of FIG. 1. FIG. 1 illustrates two TSNs 3 for wired connection to the network-side communication apparatus 30, but three or more TSNs 3 may be provided for wired connection to the network-side communication apparatus 30. The number of TSNs 3 for wired connection to the network-side communication apparatus 30 is not limited to the example of FIG. 1. In FIG. 1, the TSNs 3 include one control device 50, but may include two or more control devices 50. The number of control devices 50 included in each TSN 3 is not limited to the example of FIG. 1.

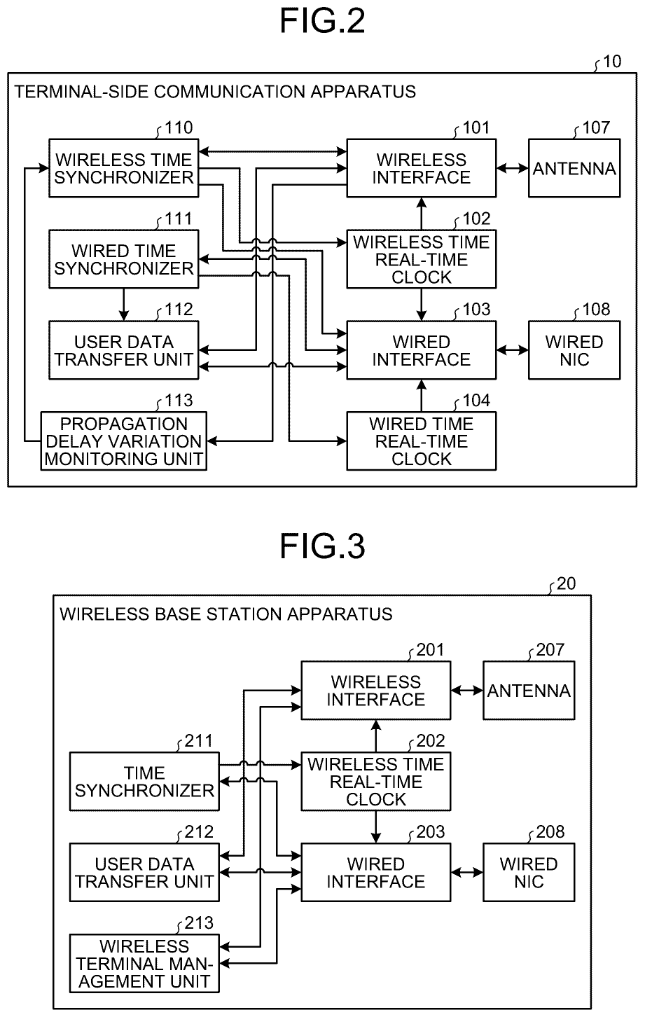

FIG. 2 is a block diagram illustrating an example configuration of each terminal-side communication apparatus 10 according to the present embodiment. The terminal-side communication apparatus 10 includes a wireless interface 101, a wireless time real-time clock 102, a wired interface 103, a wired time real-time clock 104, an antenna 107, a wired Network Interface Card (NIC) 108, a wireless time synchronizer 110, a wired time synchronizer 111, a user data transfer unit 112, and a propagation delay variation monitoring unit 113.

The wireless interface 101 has a function of transmitting and receiving wireless signals to and from the antenna 107 when wirelessly communicating with the wireless base station apparatus 20. The wireless interface 101 also has a function of establishing a wireless link with the wireless base station apparatus 20. The wireless interface 101 further has a function of communicating control-plane signals to the network-side communication apparatus 30 via the wireless base station apparatus 20. Further, the wireless interface 101 has a function of transferring, to the user data transfer unit 112, user data which the wireless interface 101 received as a wireless signal. Furthermore, the wireless interface 101 has a function of receiving, from the user data transfer unit 112, user data to be wirelessly transmitted and transmitting the user data as a wireless signal. Additionally, the wireless interface 101 receives a wireless signal time, i.e., information for wireless time synchronization. The wireless interface 101 further has a function of transferring the received time information to the wireless time synchronizer 110 and the propagation delay variation monitoring unit 113. The wireless interface 101 also has a function of transferring a reception time to the wireless time synchronizer 110 and the propagation delay variation monitoring unit 113. The reception time is the output value of the wireless time real-time clock 102 at the time the wireless interface 101 receives the wireless signal. The wireless interface 101 wirelessly receives a propagation delay correction command value. The wireless interface 101 further has a function of transferring the received propagation delay correction command value to the wireless time synchronizer 110 and the propagation delay variation monitoring unit 113. The wireless interface 101 is an interface that stamps a time output from the wireless time real-time clock 102, as a reception time when receiving a signal from the network in the wireless communication system 2. The wireless interface 101 is a wireless interface used in a user terminal in a fifth-generation communication system.

The wireless time real-time clock 102 has a function of setting a wireless time that is a time specified by the wireless time synchronizer 110. The wireless time real-time clock 102 has a function of monotonously increasing the wireless time periodically. The wireless time real-time clock 102 also has a function of outputting the wireless time to the wireless interface 101, and a function of outputting the wireless time to the wired interface 103. The wireless time real-time clock 102 is a clock for the terminal-side communication apparatus 10 to handle the time for the wireless communication system 2 described above. The wireless time real-time clock 102 outputs the time in the network in the wireless communication system 2.

The wired interface 103 has a function of transmitting and receiving wired signals to and from the wired NIC 108. The wired interface 103 also has a function of establishing a wired link with the TSN 3. The wired interface 103 has a function of receiving, from the user data transfer unit 112, user data for wired transmission and transmitting the user data as a wired signal. Further, the wired interface 103 has a function of receiving, from the wired time synchronizer 111, a time synchronization message for wired transmission and transmitting the time synchronization message as a wired signal. Furthermore, the wired interface 103 has a function of transferring, to the user data transfer unit 112, user data which the wired interface 103 received as a wired signal. Furthermore, the wired interface 103 has a function of transferring, to the wired time synchronizer 111, a wired time synchronization message in user data which the wired interface 103 received as a wired signal. The wired interface 103 has a function of transferring a wired reception time to the wired time synchronizer 111. The wired reception time is the output value of the wired time real-time clock 104 at the time the wired interface 103 receives a wired signal. The wired interface 103 a function of transferring an input timestamp to the wired time synchronizer 111. The input timestamp is the output value of the wireless time real-time clock 102 at the time the wired interface 103 receives the wired signal. The wired interface 103 has a function of transferring a wired transmission time to the wired time synchronizer 111. The wired transmission time is the output value of the wired time real-time clock 104 at the time the wired interface 103 transmits the wired signal. Further, the wired interface 103 a function of transferring an output timestamp to the wired time synchronizer 111. The output timestamp is the output value of the wireless time real-time clock 102 at the time the wired interface 103 transmits the wired signal. The wired interface 103 has a function of receiving, from the user data transfer unit 112, a time synchronization message for wired transmission, and, when transmitting a wired signal, reflecting the residence time in an information element, using a difference value between an input timestamp and an output timestamp in which clock drift output from the wireless time synchronizer 110 is taken into consideration.

The wired time real-time clock 104 has a function of setting the wired time that is a time specified by the wired time synchronizer 111. The wired time real-time clock 104 also has a function of monotonously increasing the wired time periodically. The wired time real-time clock 104 further has a function of outputting the wired time to the wired interface 103. The wired time real-time clock 104 is a clock for the terminal-side communication apparatus 10 to handle the time for the TSN 3 described above.

The antenna 107 is a physical interface in the terminal-side communication apparatus 10 when the wireless interface 101 wirelessly communicates with the wireless base station apparatus 20.

The wired NIC 108 is a physical interface in the terminal-side communication apparatus 10 when the wired interface 103 performs wired communication with the TSN 3.

The wireless time synchronizer 110 has a function of calculating the wireless time, using the propagation delay correction command value, the reception time, the time information for wireless time synchronization received as the wireless signal transferred from the wireless interface 101. The wireless time synchronizer 110 also has a function of setting the calculated wireless time in the wireless time real-time clock 102. The wireless time synchronizer 110 further has a function of calculating clock drift in accordance with a clock drift calculation timing signal output from the propagation delay variation monitoring unit 113. Furthermore, the wireless time synchronizer 110 has a function of outputting the calculated clock drift to the wired interface 103. The wireless time synchronizer 110 operates in accordance with a wireless time synchronization protocol. The wireless time synchronizer 110 is a time synchronizer that can time-synchronize with the network in the wireless communication system 2.

The wired time synchronizer 111 has a function of calculating the wired time, using a wired transmission time, a wired reception time, and a wired time synchronization message transferred from the wired interface 103 as a protocol for time synchronization with the TSN 3, and setting the calculated wired time in the wired time real-time clock 104. The wired time synchronizer 111 has a function of instructing the wired interface 103 to transmit a time synchronization message. The wired time synchronizer 111 also has a function of, using an input timestamp, a wired reception time, and a wired time synchronization message transferred from the wired interface 103, transferring, to the user data transfer unit 112, the wired time synchronization message in which an information element is updated including the addition of the input timestamp to an extended area for transfer to the TSN 3 with which a wired link is not established. The wired time synchronizer 111 operates in accordance with a wired time synchronization protocol.

The user data transfer unit 112 has a function of transferring, to the wireless interface 101, user data including a time synchronization message transferred from the wired interface 103 and the wired time synchronizer 111 in order to transmit the user data as a wireless signal. The user data transfer unit 112 also has a function of transferring, to the wired interface 103, user data received from the wireless interface 101 in order to transmit the user data as a wired signal.

The propagation delay variation monitoring unit 113 has a function of, when obtaining time information transferred from the wireless interface 101, storing the time information and the reception time of the time information, as being valid when the absolute value of the difference between a propagation delay correction command value obtained immediately before the time information and a propagation delay correction command value obtained immediately after the time information is less than or equal to a threshold. The propagation delay variation monitoring unit 113 has a function of determining that a clock drift calculation timing is provided when the absolute value of the difference between a propagation delay correction command value obtained each time the valid time information and reception time of the time information are stored and a propagation delay correction command value obtained when the previous valid time information and reception time of the time information were stored is less than or equal to the threshold. The propagation delay variation monitoring unit 113 also has a function of instructing the wireless time synchronizer 110 to calculate the clock drift.

FIG. 3 is a block diagram illustrating an example configuration of the wireless base station apparatus 20 according to the present embodiment. The wireless base station apparatus 20 includes a wireless interface 201, a wireless time real-time clock 202, a wired interface 203, an antenna 207, a wired NIC 208, a time synchronizer 211, a user data transfer unit 212, and a wireless terminal management unit 213.

The wireless interface 201 has a function of transmitting and receiving wireless signals to and from the antenna 207 when wirelessly communicating with each terminal-side communication apparatus 10. The wireless interface 201 also has a function of establishing a wireless link with the terminal-side communication apparatus 10. The wireless interface 201 further has a function of transferring, to the wireless terminal management unit 213, a control-plane signal which the wireless interface 201 received with a wireless signal from the terminal-side communication apparatus 10. The wireless interface 201 has a function of transferring, to the user data transfer unit 212, user data which the wireless interface 201 received as a wireless signal. The wireless interface 201 also has a function of receiving user data to be wirelessly transmitted from the user data transfer unit 212 and transmitting the user data as a wireless signal. The wireless interface 201 further has a function of transferring a reception time to the wireless terminal management unit 213. The reception time is the output value of the wireless time real-time clock 202 at the time the wireless interface 201 receives a wireless signal. The wireless interface 201 further has a function of transmitting a control-plane signal as a wireless signal to the appropriate terminal-side communication apparatus 10, the control-plane signal containing a propagation delay correction command output from the wireless terminal management unit 213.

The wireless time real-time clock 202 has a function of setting the wireless time that is a time specified by the time synchronizer 211. The wireless time real-time clock 202 also has a function of monotonously increasing the wireless time periodically. The wireless time real-time clock 202 further has a function of outputting the wireless time to the wireless interface 201, and a function of outputting the wireless time to the wired interface 203. The wireless time real-time clock 202 is a clock for the wireless base station apparatus 20 to handle the time for the wireless communication system 2.

The wired interface 203 has a function of transmitting and receiving wired signals to and from the wired NIC 208. The wired interface 203 also has a function of establishing a wired link with the network-side communication apparatus 30. The wired interface 203 has a function of receiving, from the user data transfer unit 212, user data for wired transmission and transmitting the user data as a wired signal to the network-side communication apparatus 30. Further, the wired interface 203 has a function of receiving, from the time synchronizer 211, a time synchronization message for wired transmission and transmitting the time synchronization message as a wired signal. Furthermore, the wired interface 203 has a function of transferring, to the user data transfer unit 212, user data which the wired interface 203 received as a wired signal. Furthermore, the wired interface 203 has a function of transferring, to the time synchronizer 211, a wireless time synchronization message which the wired interface 203 received as a wired signal. The wired interface 203 also has a function of transferring a wired reception time to the time synchronizer 211. The wired reception time is the output value of the wireless time real-time clock 202 at the time the wired interface 203 receives a wired signal. The wired interface 203 further has a function of transmitting as a wired signal a control-plane signal to the network-side communication apparatus 30, the control-plane signal being transferred from the wireless terminal management unit 213.

The antenna 207 is a physical interface in the wireless base station apparatus 20 when the wireless interface 201 wirelessly communicates with the terminal-side communication apparatuses 10.

The wired NIC 208 is a physical interface in the wireless base station apparatus 20 when the wired interface 203 performs wired communication with the network-side communication apparatus 30.

The time synchronizer 211 has a function of calculating the wireless time, using a wired transmission time, a wired reception time, and a wireless time synchronization message transferred from the wired interface 203 as a protocol for time synchronization with the wireless time GM 40, and setting the calculated wireless time in the wireless time real-time clock 202. The time synchronizer 211 has a function of instructing the wired interface 203 to transmit a time synchronization message. The time synchronizer 211 operates in accordance with a wireless time synchronization protocol.

The user data transfer unit 212 has a function of transferring, to the wireless interface 201, user data transferred from the wired interface 203 in order to transmit the user data as a wireless signal. The user data transfer unit 212 also has a function of transferring, to the wired interface 203, user data received from the wireless interface 201 in order to transmit the user data as a wired signal.

The wireless terminal management unit 213 has a function of transferring, to the wired interface 203, information necessary for configuring the wireless communication system 2 from a control-plane signal transferred from the wireless interface 201, in order to transfer the information to the network-side communication apparatus 30. The wireless terminal management unit 213 also has a function of calculating propagation delay, etc. of each terminal-side communication apparatus 10 from reception time information and information necessary for the establishment of a wireless link, the continuation of a wireless link, etc. contained in a control-plane signal transferred from the wireless interface 201. The wireless terminal management unit 213 further has a function of transferring a propagation delay correction command value to the wireless interface 201 in order to transmit the propagation delay correction command value as a wireless signal to correct the calculated propagation delay.

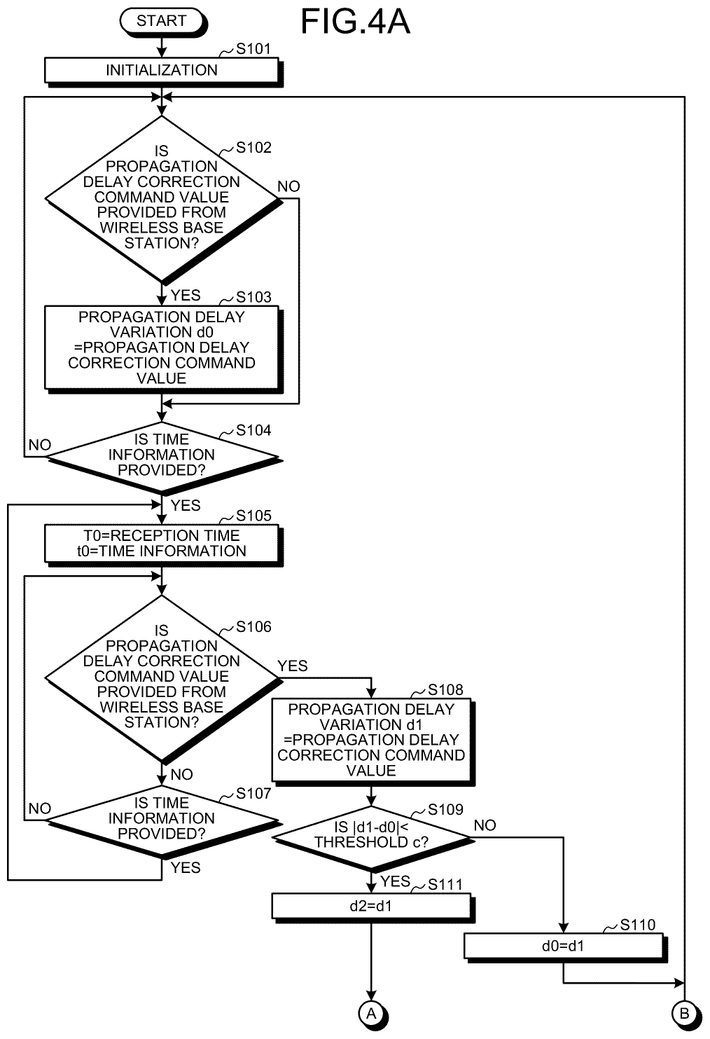

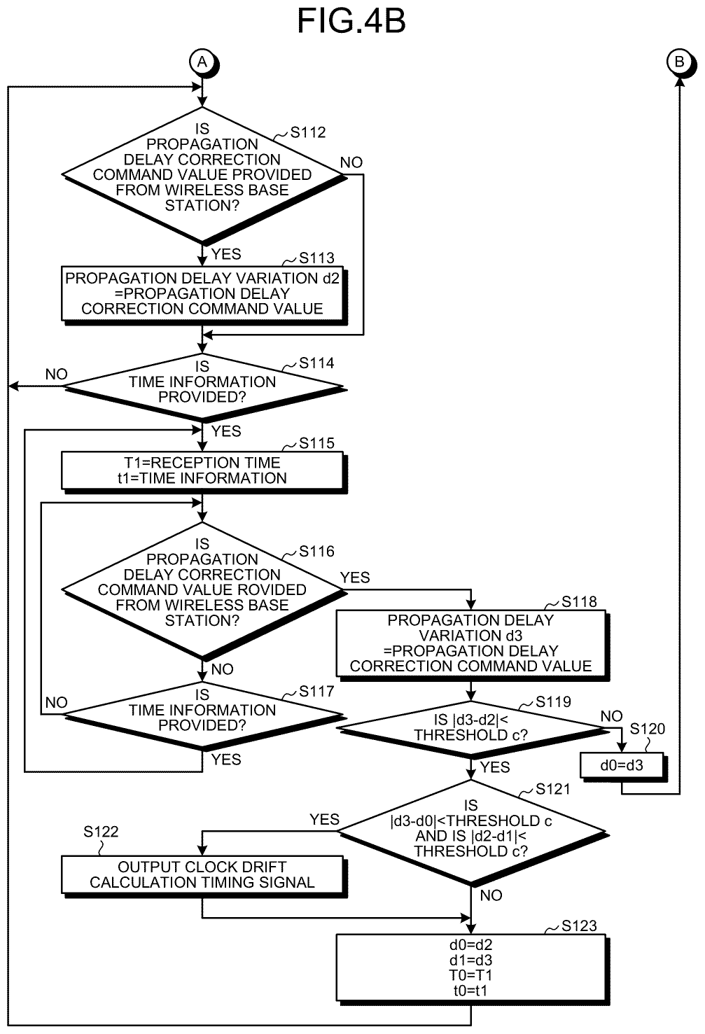

FIGS. 4A and 4B are flowcharts illustrating an operation to determine the timing at which to calculate clock drift by each terminal-side communication apparatus 10 according to the present embodiment. The flowcharts illustrated in FIGS. 4A and 4B are performed by the propagation delay variation monitoring unit 113 of the terminal-side communication apparatus 10 when a wireless link is established between the terminal-side communication apparatus 10 and the wireless base station apparatus 20.

The propagation delay variation monitoring unit 113 initializes variables used in the operation of the flowcharts illustrated in FIGS. 4A and 4B, that is, the operation of calculating clock drift (step S101).

The propagation delay variation monitoring unit 113 checks whether or not a wireless signal of a propagation delay correction command value for correcting propagation delay has been received from the wireless base station apparatus 20, that is, whether or not a propagation delay correction command value is provided from the wireless base station apparatus 20 to the terminal-side communication apparatus 10 (step S102). When a propagation delay correction command value is provided (step S102: Yes), the propagation delay variation monitoring unit 113 stores the propagation delay correction command value in a propagation delay variation variable d0 (step S103). When the propagation delay correction command value is specified as a relative value to the previous propagation delay correction command value, the propagation delay variation monitoring unit 113 may calculate an accumulated value of the propagation delay correction command values and treat the accumulated value as the propagation delay variation variable d0. When a propagation delay correction command value is not provided (step S102: No), the propagation delay variation monitoring unit 113 skips step S103.

When receiving a wireless signal, the propagation delay variation monitoring unit 113 checks whether or not time information on the wireless time of the wireless base station apparatus 20 is contained in the wireless signal (step S104). When the time information on the wireless time is not contained (step S104: No), the propagation delay variation monitoring unit 113 returns to step S102 and repeats the above-described operation. When the time information on the wireless time is contained (step S104: Yes), the propagation delay variation monitoring unit 113 stores, in a reception time variable T0, the reception time the wireless signal of the time information on the wireless time has been received from the corresponding wireless base station apparatus 20, and stores, in a time information variable t0, the time information on the wireless time of the corresponding wireless base station apparatus 20 (step S105).

The propagation delay variation monitoring unit 113 checks whether or not a wireless signal of the latest propagation delay correction command value for correcting propagation delay has been received from the wireless base station apparatus 20, that is, whether or not the latest propagation delay correction command value is provided from the wireless base station apparatus 20 to the terminal-side communication apparatus 10 (step S106). In step S106, waiting for an immediately following propagation delay correction command value, the propagation delay variation monitoring unit 113 checks whether or not the time information and the reception time are valid without propagation delay variation. When a propagation delay correction command value is not provided (step S106: No), the propagation delay variation monitoring unit 113 checks whether or not the latest time information has been received from the wireless base station apparatus 20 (step S107). When the latest time information has been received (step S107: Yes), the propagation delay variation monitoring unit 113 updates the reception time variable T0 with the latest reception time, and updates the time information variable t0 with the latest time information (step S105). When the latest time information has not been received (step S107: No), the propagation delay variation monitoring unit 113 returns to step S106. When a propagation delay correction command value is provided (step S106: Yes), the propagation delay variation monitoring unit 113 stores the propagation delay correction command value in a propagation delay variation variable d1 (step S108).

The propagation delay variation monitoring unit 113 calculates the absolute value of the difference between the propagation delay variation variable d0 having the previous propagation delay correction command value stored therein and the propagation delay variation variable d1 having the latest propagation delay correction command value stored therein, and compares the calculated absolute value of the difference with a specified threshold c (step S109). The threshold c represents to what extent the effect of propagation delay variation is acceptable in the calculation of clock drift. The higher the threshold c, the more the propagation delay variation monitoring unit 113 accepts propagation delay variation and calculates clock drift. When the calculated absolute value of the difference is higher than the threshold c (step S109: No), the propagation delay variation monitoring unit 113 updates the propagation delay variation variable d0 with the propagation delay variation variable d1 (step S110), and returns to step S102. When the calculated absolute value of the difference is lower than the threshold c (step S109: Yes), the propagation delay variation monitoring unit 113 treats the time information and the reception time as being valid, and stores, in a latest propagation delay variation variable d2, the same value as the propagation delay variation variable d1 (step S111).

The propagation delay variation monitoring unit 113 checks whether or not a wireless signal of the latest propagation delay correction command value for correcting propagation delay is received from the wireless base station apparatus 20, that is, whether or not the latest propagation delay correction command value is provided from the wireless base station apparatus 20 to the terminal-side communication apparatus 10 (step S112). When a propagation delay correction command value is provided (step S112: Yes), the propagation delay variation monitoring unit 113 stores the propagation delay correction command value in the propagation delay variation variable d2 and updates the propagation delay variation variable d2 (step S113). When a propagation delay correction command value is not provided (step S112: No), the propagation delay variation monitoring unit 113 skips step S113.

The propagation delay variation monitoring unit 113 checks whether or not the latest time information has been received from the wireless base station apparatus 20 (step S114). When the latest time information has not been received (step S114: No), the propagation delay variation monitoring unit 113 returns to step S112. When the latest time information has been received (step S114: Yes), the propagation delay variation monitoring unit 113 stores, in a reception time variable T1, the reception time a wireless signal of the time information on the wireless time has been received from the corresponding wireless base station apparatus 20, and stores, in a time information variable t1, the time information on the wireless time of the corresponding wireless base station apparatus 20 (step S115).

To check whether or not the variables T1 and t1 are valid values, the propagation delay variation monitoring unit 113 checks whether or not a wireless signal of the latest propagation delay correction command value for correcting propagation delay has been received from the wireless base station apparatus 20, that is, whether or not the latest propagation delay correction command value is provided from the wireless base station apparatus 20 to the terminal-side communication apparatus 10 (step S116). When a propagation delay correction command value is not provided (step S116: No), the propagation delay variation monitoring unit 113 checks whether or not the latest time information has been received from the wireless base station apparatus 20 (step S117). When the latest time information has been received (step S117: Yes), the propagation delay variation monitoring unit 113 updates the reception time variable T1 with the latest reception time, and updates the time information variable t1 with the latest time information (step S115). When the latest time information has not been received (step S117: No), the propagation delay variation monitoring unit 113 returns to step S116. When a propagation delay correction command value is provided (step S116: Yes), the propagation delay variation monitoring unit 113 stores the propagation delay correction command value in a transmission delay variation variable d3 (step S118).

The propagation delay variation monitoring unit 113 calculates the absolute value of the difference between the transmission delay variation variable d2 having the previous propagation delay correction command value stored therein and the transmission delay variation variable d3 having the latest propagation delay correction command value stored therein, and compares the calculated absolute value of the difference with the specified threshold c (step S119). When the calculated absolute value of the difference is higher than the threshold c (step S119: No), the propagation delay variation monitoring unit 113 updates the transmission delay variation variable d0 with the transmission delay variation variable d3 (step S120), and returns to step S102. When the calculated absolute value of the difference is lower than the threshold c (step S119: Yes), the propagation delay variation monitoring unit 113 determines that the variables T1 and t1 are valid.

To check whether or not propagation delay variation between the valid variables T0 and t0 and the valid variables T1 and t1 is small, the propagation delay variation monitoring unit 113 compares the absolute value of the difference between the transmission delay variation variable d3 and the transmission delay variation variable d0 with the threshold c, and compares the absolute value of the difference between the transmission delay variation variable d2 and the transmission delay variation variable d1 with the threshold c (step S121). When the absolute value of the difference between the variable d3 and the variable d0 is lower than the threshold c, and the absolute value of the difference between the variable d2 and the variable d1 is lower than the threshold c (step S121: Yes), the propagation delay variation monitoring unit 113 determines that it is timing to calculate clock drift, and outputs a clock drift calculation timing signal to the wireless time synchronizer 110 (step S122). When the absolute value of the difference between the variable d3 and the variable d0 is higher than the threshold c, or the absolute value of the difference between the variable d2 and the variable d1 is higher than the threshold c, or the absolute value of the difference between the variable d3 and the variable d0 is higher than the threshold c and the absolute value of the difference between the variable d2 and the variable d1 is higher than the threshold c (step S121: No), the propagation delay variation monitoring unit 113 skips step S122.

Variables used when the wireless time synchronizer 110 calculates clock drift are the variables T0, t0, T1, and t1, and clock drift is calculated as shown in equation (1). The propagation delay variation monitoring unit 113 thus outputs the variables T0, t0, T1, and t1 to the wireless time synchronizer 110 together with the clock drift calculation timing signal. The propagation delay variation monitoring unit 113 may output, to the wireless time synchronizer 110, a clock drift calculation timing signal containing the variables T0, t0, T1, and t1.

$$Clock drift = ( T 1 - T 0 ) / ( t 1 - t 0 ) \qquad ( 1 )$$

After step S122 or in the case of step S121: No, the propagation delay variation monitoring unit 113 initializes the variables (step S123). Specifically, the propagation delay variation monitoring unit 113 initializes the propagation delay variation variable d0 with the propagation delay variation variable d2, and initializes the transmission delay variation variable d1 with the transmission delay variation variable d3. The propagation delay variation monitoring unit 113 initializes the reception time variable T0 with the reception time variable T1, and initializes the time information variable t0 with the time information variable t1. After step S123, the propagation delay variation monitoring unit 113 returns to step S112 and performs an operation to determine the next clock drift calculation timing.

For the threshold c, a value that satisfies an inequality shown in equation (2) below can be set from ideal clock drift ideally calculated in an environment without propagation delay variation with respect to the following required clock drift.

$$Required clock drift > ( ( t 1 - t 0 ) + ( ideal clock drift - 1 ) \times ( t 1 - t 0 ) + propagation delay variation / ( t 1 - t 0 ) \to ( t 1 - t 0 ) \times ( required clock drift - ideal clock drift ) > error due to propagation delay variation \qquad ( 2 )$$

The value of the threshold c can be uniquely determined by synchronization accuracy required of services in the TSN system 1, the amount of forward delay of the wireless communication system 2, the transmission period of wireless time information, the amount of clock drift acceptable for propagation delay variation, etc. The amount of forward delay of the wireless communication system 2 is also referred to as residence time. The threshold c can be said to be determined from the maximum residence time assumed when signals transferred between the plurality of TSNs 3 via the network in the wireless communication system 2 are transferred through the network in the wireless communication system 2, and time synchronization accuracy required in the TSNs 3.

In the following description, the time information variable t0 is sometimes referred to as first time information, the reception time variable T0 as a first reception time, the time information variable t1 as second time information, and the reception time variable T1 as a second reception time. The transmission delay variation variable d0 is sometimes referred to as a first propagation delay correction command value, the transmission delay variation variable d1 as a second propagation delay correction command value, the transmission delay variation variable d2 as a third propagation delay correction command value, and the transmission delay variation variable d3 as a fourth propagation delay correction command value.

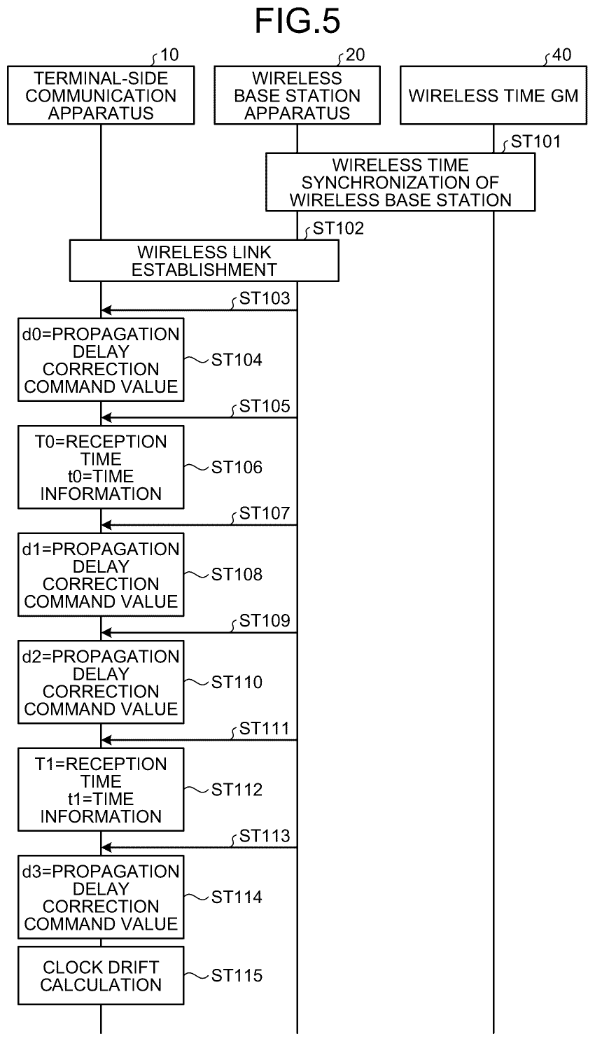

FIG. 5 is a sequence diagram illustrating operations of the apparatuses until the terminal-side communication apparatus 10 calculates clock drift in the wireless communication system 2 according to the present embodiment.

The wireless base station apparatus 20 and the wireless time GM 40 perform wireless time synchronization of the wireless base station apparatus 20 (step ST101). Consequently, the wireless base station apparatus 20 can handle the wireless time.

The terminal-side communication apparatus 10 and the wireless base station apparatus 20 establish a wireless link with each other (step ST102). By establishing the wireless link, the terminal-side communication apparatus 10 and the wireless base station apparatus 20 can transmit and receive wireless signals such as control-plane data and user data therebetween. From this stage, the propagation delay variation monitoring unit 113 of the terminal-side communication apparatus 10 starts to monitor propagation delay variation.

The wireless base station apparatus 20 transmits, to the terminal-side communication apparatus 10, a wireless signal containing a command to correct propagation delay with a propagation delay correction command value (step ST103). Generally, when an uplink and a downlink are formed by time-sharing the same frequency band like time-division duplexing, uplink propagation delay and downlink propagation delay are considered to be the same. A fifth-generation communication system can use a Timing Advance Command (TAC) at the Medium Access Control (MAC) layer. That is, a signal containing a propagation delay correction command value from the network in the wireless communication system 2 is a TAC at the MAC layer of the wireless interface of the fifth-generation communication system.

In the terminal-side communication apparatus 10, the propagation delay variation monitoring unit 113 stores the propagation delay correction command value, received in step ST103, as the propagation delay variation variable d0 (step ST104).

The wireless base station apparatus 20 transmits, to the terminal-side communication apparatus 10, a wireless signal containing wireless time information (step ST105). A fifth-generation communication system can use the System Information Block type 9 (SIB 9), which is time information at the RRC layer, since SIB 9 is time information periodically transmitted. That is, the time information from the network in the wireless communication system 2 is an information element of SIB 9. Alternatively, in a case where PTP is adopted as the wireless time synchronization protocol, a Sync message having a timestamp periodically stored therein and a Follow_Up message can be used because the wireless base station apparatus 20 operate as a PTP master to thereby transmit the Sync message and the Follow_Up message to the terminal-side communication apparatus 10. That is, the wireless time synchronizer 110 operates as a PTP slave. In this case, the time information from the network in the wireless communication system 2 is an information element included in either a Sync message periodically multicast from the PTP master present on the network in the wireless communication system 2 or a Follow_Up message multicast immediately after the Sync message.

Alternatively, by periodically transmitting a Delay_Req message from the terminal-side communication apparatus 10 to the PTP master, a Delay_Resp message periodically returned can be received by the terminal-side communication apparatus 10, and thus can be used. In a case where NTP is adopted as the wireless time synchronization protocol, for example, with the terminal-side communication apparatus 10 as an NTP client, by periodically transmitting a Mode 3 packet to an NTP server in the wireless communication system 2 synchronized with the wireless time GM 40 of the wireless communication system 2, a periodic Mode 4 packet is expected to be received by the terminal-side communication apparatus 10, and thus can be used. The NTP server in the wireless communication system 2 may be the wireless base station apparatus 20 when the wireless base station apparatus 20 also operates as the NTP server. That is, using an NTP packet, the wireless time synchronizer 110 as the NTP client periodically inquires of the NTP server present on the network in the wireless communication system 2. In this case, the time information from the network in the wireless communication system 2 is an information element included in a response to the NTP packet inquiry, the response being provided by the NTP server present on the network in the wireless communication system 2.

In the terminal-side communication apparatus 10, the propagation delay variation monitoring unit 113 stores the reception time in the reception time variable T0, stores the time information in the time information variable t0, and proceeds to determination as to whether the variables are valid values obtained with a small propagation delay variation (step ST106).

The wireless base station apparatus 20 transmits, to the terminal-side communication apparatus 10, a wireless signal containing a command to correct propagation delay with a propagation delay correction command value (step ST107).

In the terminal-side communication apparatus 10, the propagation delay variation monitoring unit 113 stores the latest propagation delay correction command value in the propagation delay variation variable d1 (step ST108). The propagation delay variation monitoring unit 113 determines whether or not the variables T0 and t0 are valid values from the absolute value of the difference between the propagation delay variation variable d1 and the propagation delay variation variable d0. The example of FIG. 5 illustrates a sequence when the variables T0 and t0 are valid. When the propagation delay variation monitoring unit 113 can determine that the variables T0 and t0 are valid, the propagation delay variation monitoring unit 113 performs propagation delay variation monitoring again to obtain the next valid variables T1 and t1.

The wireless base station apparatus 20 transmits, to the terminal-side communication apparatus 10, a wireless signal containing a command to correct propagation delay with a propagation delay correction command value (step ST109).

In the terminal-side communication apparatus 10, the propagation delay variation monitoring unit 113 stores the propagation delay correction command value, received in step ST109, as the propagation delay variation variable d2 (step ST110).

The wireless base station apparatus 20 transmits, to the terminal-side communication apparatus 10, a wireless signal containing wireless time information (step ST111).

In the terminal-side communication apparatus 10, the propagation delay variation monitoring unit 113 stores the reception time in the reception time variable T1, stores the time information in the time information variable t1, and proceeds to determination as to whether the variables are valid values obtained with a small propagation delay variation (step ST112).

The wireless base station apparatus 20 transmits, to the terminal-side communication apparatus 10, a wireless signal containing a command to correct propagation delay with a propagation delay correction command value (step ST113).

In the terminal-side communication apparatus 10, the propagation delay variation monitoring unit 113 stores the latest propagation delay correction command value in the propagation delay variation variable d3 (step ST114). The propagation delay variation monitoring unit 113 determines whether or not the variables T1 and t1 are valid values from the absolute value of the difference between the propagation delay variation variable d3 and the propagation delay variation variable d2. The example of FIG. 5 illustrates a sequence when the variables T1 and t1 are valid.

The propagation delay variation monitoring unit 113 determines that the timing to calculate clock drift is provided, and outputs a clock drift calculation timing signal to the wireless time synchronizer 110 where the absolute value of the difference between the variable d3 and the variable d0 is lower than the threshold c and the absolute value of the difference between the variable d2 and the variable d1 is lower than the threshold c when the variables T0, t0, T1, and t1 are valid. Then, the wireless time synchronizer 110 calculates clock drift (step ST115).

By following the sequence as illustrated in FIG. 5, the terminal-side communication apparatus 10 even in an environment where propagation delay varies, can calculate clock drift while reducing the effect of the propagation delay variation.

Next, a hardware configuration of the terminal-side communication apparatus 10 will be described. In the terminal-side communication apparatus 10, the wireless interface 101 is an interface circuit capable of wireless communication. The wireless time real-time clock 102 is a circuit that generates a clock for wireless communication. The wired interface 103 is an interface circuit capable of wired communication. The wired time real-time clock 104 is a circuit that generates a clock for wired communication. The antenna 107 is a device that transmits and receives radio waves. The wired NIC 108 is an interface card used in wired communication. In the terminal-side communication apparatus 10, the wireless time synchronizer 110, the wired time synchronizer 111, the user data transfer unit 112, and the propagation delay variation monitoring unit 113 are implemented by processing circuitry. The processing circuitry may be a processor to execute a program stored in memory and the memory, or may be dedicated hardware. The processing circuitry is also referred to as a control circuit.

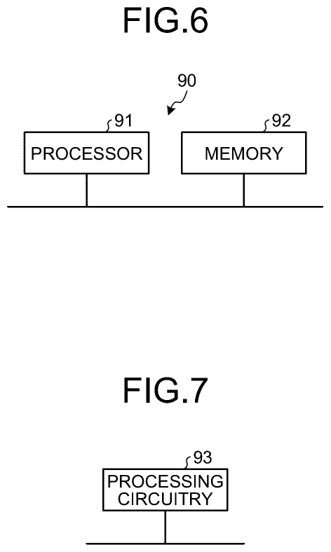

FIG. 6 is a diagram illustrating a configuration example of processing circuitry 90 when a processor 91 and memory 92 implement processing circuitry for implementing each terminal-side communication apparatus 10 according to the present embodiment. The processing circuitry 90 illustrated in FIG. 6 is a control circuit and includes the processor 91 and the memory 92. When the processor 91 and the memory 92 constitute the processing circuitry 90, functions of the processing circuitry 90 are implemented by software, firmware, or a combination of software and firmware. The software or firmware is described as a program and stored in the memory 92. In the processing circuitry 90, the processor 91 reads and executes the program stored in the memory 92, thereby implementing each function. That is, the processing circuitry 90 includes the memory 92 for storing the program that results in the execution of processing in the terminal-side communication apparatus 10. This program can be said to be a program for causing the terminal-side communication apparatus 10 to perform each function implemented by the processing circuitry 90. This program may be provided via a storage medium on which the program is stored, or may be provided via another means such as a communication medium.

The program can be said to be a program to cause the terminal-side communication apparatus 10 to perform a first step in which the wireless time synchronizer 110 time-synchronizes with the first network, a second step in which the wireless time real-time clock 102 outputs the time in the first network, a third step in which the wireless interface 101 stamps the time as a reception time when receiving a signal from the first network, and a fourth step in which the propagation delay variation monitoring unit 113 stores: a propagation delay correction command value for correcting propagation delay from the first network, time information contained in a signal, and the reception time of the time information, the propagation delay correction command value and the signal being received by the wireless interface 101, determines the state of propagation delay in the first network, using the propagation delay correction command value, the time information, and the reception time, determines that timing to calculate clock drift with respect to the first network is provided and instructs the wireless time synchronizer 110 to calculate the clock drift when the propagation delay is within an acceptable level.

Here, the processor 91 is, for example, a Central Processing Unit (CPU), a processing device, an arithmetic device, a microprocessor, a microcomputer, a Digital Signal Processor (DSP), or the like. The memory 92 corresponds, for example, to nonvolatile or volatile semiconductor memory such as Random-Access Memory (RAN), Read-Only Memory (ROM), flash memory, an Erasable Programmable ROM (EPROM), or an Electrically EPROM (EEPROM) (registered trademark), or a magnetic disk, a flexible disk, an optical disc, a compact disc, a mini disc, a Digital Versatile Disc (DVD), or the like.

FIG. 7 is a diagram illustrating an example of processing circuitry 93 when dedicated hardware constitutes the processing circuitry for implementing each terminal-side communication apparatus 10 according to the present embodiment. The processing circuitry 93 illustrated in FIG. 7 corresponds, for example, to a single circuit, a combined circuit, a programmed processor, a parallel-programmed processor, an Application-Specific Integrated Circuit (ASIC), a Field-Programmable Gate Array (FPGA), or a combination of them. The processing circuitry may be implemented partly by dedicated hardware and partly by software or firmware. Thus, the processing circuitry can implement the above-described functions by dedicated hardware, software, firmware, or a combination of them.

The hardware configuration of the wireless base station apparatus 20 is the same. In the wireless base station apparatus 20, the wireless interface 201 is an interface circuit capable of wireless communication. The wireless time real-time clock 202 is a circuit that generates a clock for wireless communication. The wired interface 203 is an interface circuit capable of wired communication. The antenna 207 is a device that transmits and receives radio waves. The wired NIC 208 is an interface card used in wired communication. In the wireless base station apparatus 20, the time synchronizer 211, the user data transfer unit 212, and the wireless terminal management unit 213 are implemented by the processing circuitry. The processing circuitry may be a processor to execute a program stored in memory and the memory, or may be dedicated hardware. The processing circuitry is also referred to as a control circuit.

As described above, according to the present embodiment, in each terminal-side communication apparatus 10, the propagation delay variation monitoring unit 113 stores: a propagation delay correction command value for correcting propagation delay from the network in the wireless communication system 2; time information contained in a signal; and the reception time of the time information, the propagation delay correction command value and the signal being received by the wireless interface 101, and determines the state of propagation delay in the network in the wireless communication system 2, using the propagation delay correction command value, the time information, and the reception time. When the propagation delay is within the acceptable level, the propagation delay variation monitoring unit 113 determines that timing to calculate clock drift with respect to the network in the wireless communication system 2 is provided and instructs the wireless time synchronizer 110 to calculate the clock drift.

Specifically, when the absolute value of the difference between the first propagation delay correction command value obtained before the obtainment of the first time information and the first reception time, and the second propagation delay correction command value obtained after the obtainment of the first time information and the first reception time is lower than the specified threshold c, the propagation delay variation monitoring unit 113 holds the first time information, the first reception time, the first propagation delay correction command value, and the second propagation delay correction command value as being valid. When the absolute value of the difference between the third propagation delay correction command value obtained before the obtainment of the second time information and the second reception time, and the fourth propagation delay correction command value obtained after the obtainment of the second time information and the second reception time is lower than the threshold c, the propagation delay variation monitoring unit 113 holds the second time information, the second reception time, the third propagation delay correction command value, and the fourth propagation delay correction command value as being valid. When the absolute value of the difference between the first propagation delay correction command value and the fourth propagation delay correction command value is lower than the threshold c, and the absolute value of the difference between the second propagation delay correction command value and the third propagation delay correction command value is lower than the threshold c, the propagation delay variation monitoring unit 113 determines that timing to calculate the clock drift is provided and instructs the wireless time synchronizer 110 to calculate the clock drift.

The wireless time synchronizer 110 that has received the instruction from the propagation delay variation monitoring unit 113 calculates the clock drift, using the first time information, the first reception time, the second time information, and the second reception time.

Thus, the terminal-side communication apparatus 10 can determine that time information and a reception time with propagation delay varying should not be used to calculate the clock drift. Consequently, even in an environment where propagation delay varies, the terminal-side communication apparatus 10, which is a component of the virtual bridge and is a communication apparatus corresponding to a terminal, can calculate the clock drift while reducing the effect of the propagation delay.

The communication apparatus according to the present disclosure, which is the component of the virtual bridge, has the effect of calculating the clock drift while reducing the effect of propagation delay even in an environment where the propagation delay varies.

The configuration described in the above embodiment illustrates an example, and can be combined with another known art. The embodiments can be combined with each other. The configuration can be partly omitted or changed without departing from the gist.

What is claimed is:

1. A communication apparatus to transfer signals between a first network and a second network, the communication apparatus comprising:
time synchronizer circuitry capable of time-synchronizing with the first network;
clock circuitry to output a time in the first network;
interface circuitry to stamp the time as a reception time when receiving a signal from the first network; and
propagation delay variation monitoring circuitry to store: a propagation delay correction command value for correcting propagation delay from the first network; time information contained in a signal; and a reception time of the time information, the propagation delay correction command value and the signal being received by the interface circuitry, determine a state of propagation delay in the first network, using the propagation delay correction command value, the time information, and the reception time, and determine that timing to calculate clock drift with respect to the first network is provided and instruct the time synchronizer circuitry to calculate the clock drift when the propagation delay is within an acceptable level.

2. The communication apparatus according to claim 1, wherein
when an absolute value of a difference between a first propagation delay correction command value obtained before obtainment of first time information and a first reception time and a second propagation delay correction command value obtained after obtainment of the first time information and the first reception time is lower than a specified threshold, the propagation delay variation monitoring circuitry holds the first time information, the first reception time, the first propagation delay correction command value, and the second propagation delay correction command value as being valid,
when an absolute value of a difference between a third propagation delay correction command value obtained before obtainment of second time information and a second reception time and a fourth propagation delay correction command value obtained after obtainment of the second time information and the second reception time is lower than the threshold, the propagation delay variation monitoring circuitry holds the second time information, the second reception time, the third propagation delay correction command value, and the fourth propagation delay correction command value as being valid, and
the propagation delay variation monitoring circuitry determines that timing to calculate the clock drift is provided and instructs the time synchronizer circuitry to calculate the clock drift when an absolute value of a difference between the first propagation delay correction command value and the fourth propagation delay correction command value is lower than the threshold, and an absolute value of a difference between the second propagation delay correction command value and the third propagation delay correction command value is lower than the threshold.

3. The communication apparatus according to claim 2, wherein
the threshold is determined from a maximum residence time assumed when a signal transferred between a plurality of the second networks via the first network is transferred through the first network, and time synchronization accuracy required in the second networks.

4. The communication apparatus according to claim 2, wherein
the time synchronizer circuitry calculates the clock drift, using the first time information, the first reception time, the second time information, and the second reception time.

5. The communication apparatus according to claim 1, wherein
the interface circuitry is a wireless interface used in a user terminal in a fifth-generation communication system, and
a signal containing the propagation delay correction command value from the first network is a Timing Advance Command at the Medium Access Control layer of a wireless interface of the fifth-generation communication system.

6. The communication apparatus according to claim 1, wherein
the interface circuitry is a wireless interface used in a user terminal in a fifth-generation communication system, and
the time information from the first network is an information element of the System Information Block type 9.

7. The communication apparatus according to claim 1, wherein
using a Network Time Protocol packet, the time synchronizer circuitry as a Network Time Protocol client periodically inquires of a Network Time Protocol server present on the first network, and
the time information from the first network is an information element included in a response to a Network Time Protocol packet inquiry, the response being provided by the Network Time Protocol server present on the first network.

8. The communication apparatus according to claim 1, wherein
the time synchronizer circuitry operates as a Precise Time Protocol slave, and
the time information from the first network is an information element included in either a Sync message that is periodically multicast from a Precise Time Protocol master present on the first network or a Follow_Up message that is multicast immediately after the Sync message.

9. A control circuit to control a communication apparatus to transfer signals between a first network and a second network, the control circuit causing the communication apparatus to:
time-synchronize with the first network;
output a time in the first network;
stamp the time as a reception time when receiving a signal from the first network; and
store: a propagation delay correction command value for correcting propagation delay from the first network; time information contained in a signal; and a reception time of the time information, the propagation delay correction command value and the signal being received, determine a state of propagation delay in the first network, using the propagation delay correction command value, the time information, and the reception time, and determine that timing to calculate clock drift with respect to the first network is provided and provide an instruction to calculate the clock drift when the propagation delay is within an acceptable level.

10. A clock drift calculation timing determination method for a communication apparatus to transfer signals between a first network and a second network, the method comprising:
time-synchronizing with the first network;
outputting a time in the first network;
stamping the time as a reception time when receiving a signal from the first network; and
storing: a propagation delay correction command value for correcting propagation delay from the first network; time information contained in a signal; and a reception time of the time information, the propagation delay correction command value and the signal being received by the interface, determining a state of propagation delay in the first network, using the propagation delay correction command value, the time information, and the reception time, and determining that timing to calculate clock drift with respect to the first network is provided and providing an instruction to calculate the clock drift when the propagation delay is within an acceptable level.

11. The clock drift calculation timing determination method according to claim 10, wherein storing the propagation delay correction command value, the time information, and the reception time includes:
when an absolute value of a difference between a first propagation delay correction command value obtained before obtainment of first time information and a first reception time and a second propagation delay correction command value obtained after obtainment of the first time information and the first reception time is lower than a specified threshold, holding the first time information, the first reception time, the first propagation delay correction command value, and the second propagation delay correction command value as being valid, and
when an absolute value of a difference between a third propagation delay correction command value obtained before obtainment of second time information and a second reception time and a fourth propagation delay correction command value obtained after obtainment of the second time information and the second reception time is lower than the threshold, holding the second time information, the second reception time, the third propagation delay correction command value, and the fourth propagation delay correction command value as being valid, and, wherein
the determination of the timing to calculate the clock drift and the instruction to calculate the clock drift are made when an absolute value of a difference between the first propagation delay correction command value and the fourth propagation delay correction command value is lower than the threshold, and an absolute value of a difference between the second propagation delay correction command value and the third propagation delay correction command value is lower than the threshold.

12. The clock drift calculation timing determination method according to claim 11, wherein
the threshold is determined from a maximum residence time assumed when a signal transferred between a plurality of the second networks via the first network is transferred through the first network, and time synchronization accuracy required in the second networks.

13. The clock drift calculation timing determination method according to claim 11, comprising
calculating the clock drift, using the first time information, the first reception time, the second time information, and the second reception time.

14. The clock drift calculation timing determination method according to claim 10, wherein
the communication apparatus includes an interface, and the interface is a wireless interface used in a user terminal in a fifth-generation communication system, and
a signal containing the propagation delay correction command value from the first network is a Timing Advance Command at the Medium Access Control layer of a wireless interface of the fifth-generation communication system.

15. The clock drift calculation timing determination method according to claim 10, wherein
the communication apparatus includes an interface, and the interface is a wireless interface used in a user terminal in a fifth-generation communication system, and
the time information from the first network is an information element of the System Information Block type 9.

16. The clock drift calculation timing determination method according to claim 10, wherein
the communication apparatus includes a time synchronizer as a Network Time Protocol client, time-synchronizing with the first network includes allowing the time synchronizer to periodically inquire of a Network Time Protocol server present on the first network, using a Network Time Protocol packet, and
the time information from the first network is an information element included in a response to a Network Time Protocol packet inquiry, the response being provided by the Network Time Protocol server present on the first network.

17. The clock drift calculation timing determination method according to claim 10, wherein
the communication apparatus includes a time synchronizer, time-synchronizing with the first network includes allowing the time synchronizer to operate as a Precise Time Protocol slave, and
the time information from the first network is an information element included in either a Sync message that is periodically multicast from a Precise Time Protocol master present on the first network or a Follow_Up message that is multicast immediately after the Sync message.
